(19) United States
(12) Patent Application Publication
(10) Pub. No.: US 2026/0209607 A1
(43) Pub. Date: Jul. 23, 2026

(54) SYSTEMS AND METHODS FOR CONTROLLING A PROCESS UPSET IN A WET CRUDE HANDLING UNIT

(71) Applicant: SAUDI ARABIAN OIL COMPANY, Dhahran (SA)

(72) Inventors: Ali Hemoud Hassan ALSHEHRI, Dhahran (SA); Samusideen Adewale SALU, Dhahran (SA)

(73) Assignee: SAUDI ARABIAN OIL COMPANY, Dhahran (SA)

(21) Appl. No.: 19/034,898

(22) Filed: Jan. 23, 2025

(51) Int. Cl. C10G 5/00; G05B 13/02

(52) U.S. Cl. CPC C10G 5/00; G05B 13/0265; C10G 2300/1037

(57) ABSTRACT

Systems and methods provided herein include a controller for a gas oil separation plant (GOSP). The controller may include a memory and one or more processors coupled to the memory. The one or more processors may be configured to cause the controller to perform, in real-time: detecting at least one deficiency at a GOSP unit having one or more adjustable equipment components, the at least one deficiency comprising at least one parameter exiting at least one threshold range, and, based on the detecting, adjusting the one or more adjustable equipment components to return the at least one parameter to the at least one threshold range

### FIELD OF THE DISCLOSURE

The present disclosure relates generally to upstream oil and gas processing, and more particularly to controlling the process upset in wet crude handling unit (WCHU) within gas oil separation plant (GOSP).

### BACKGROUND OF THE DISCLOSURE

Gas oil separation plants (GOSPs) are essential for upstream oil and gas production due to their role in the initial separation of crude oil from natural gas and water. This initial separation ensures that crude oil meets quality standards necessary for refining and transportation, maintaining the integrity of the production process. GOSPs also enhance production efficiency by optimizing resource utilization. By separating oil and gas early, GOSPs allow for more efficient processing and reduce transportation costs, as oil and gas can be handled separately. This streamlines operations and minimizes waste, ensuring effective use of resources.

Although current techniques implemented during GOSP processing, and specifically for wet crude handling units (WCHUs) implemented at GOSPs, are based on technological advancements made over many years, current processing techniques may still be ineffective to achieve ideal separation results. For example, control systems for WCHUs within GOSPs may be unreliable and inefficient. Accordingly, there is an impetus to improve GOSP processing technology to overcome current technological challenges by implementing improvements including, for example: enhancing the control systems within a WCHU, reducing inefficiencies associated with GOSP processing systems, increasing the throughput of GOSP processing systems, reducing errors associated with current control systems, decreasing the cost of WCHU processing, and the like.

Consequently, there exists a need for further improvements in GOSP processing technology to overcome the aforementioned technical challenges and other challenges not mentioned.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a controller for a gas oil separation plant (GOSP), may include a memory, and one or more processors coupled to the memory. In one example, the one or more processors may be configured to cause the controller to perform, in real-time: detecting at least one deficiency at a GOSP unit having one or more adjustable equipment components, the at least one deficiency including at least one parameter exiting at least one threshold range, and based on the detecting, adjusting the one or more adjustable equipment components to return the at least one parameter to the at least one threshold range.

In another embodiment, a system for a gas oil separation plant (GOSP) may include a wet crude handling unit (WCHU) coupled to and in communication with a controller, and a controller, including a memory, and one or more processors coupled to the memory. In one example, the one or more processors may be configured to cause the controller to perform, in real-time: detecting at least one deficiency at a GOSP unit having one or more adjustable equipment components, the at least one deficiency including at least one parameter exiting at least one threshold range, and based on the detecting, adjusting the one or more adjustable equipment components to return the at least one parameter to the at least one threshold range.

In another embodiment, a method for a gas oil separation plant (GOSP) may include monitoring, in-real time, the at least one GOSP unit, detecting, at least one deficiency at the GOSP unit having one or more adjustable equipment components, the at least one deficiency including at least one parameter exiting at least one threshold range, based on the detecting, adjusting the one or more adjustable equipment components to return the at least one parameter to the at least one threshold range, and storing GOSP performance information, the GOSP performance information generated based on the detecting.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a flow diagram illustrating a procedure for implementing an advanced integrated control system, described according to one or more embodiment of the present disclosure.

FIG. 2 is a diagram of a unit within an integrated control system, described according to one or more embodiments of the present disclosure.

FIG. 3 is a schematic diagram illustrating an example unit which may be controlled by an integrated control system according to one or more embodiments of the present disclosure.

FIG. 4 is a schematic diagram of an example system, according to at least one embodiment of the present disclosure.

FIG. 5 is a schematic flowchart of an example method for a gas oil separation plant (GOSP), according to at least one embodiment of the present disclosure.

FIG. 6 is a block diagram of a computer system that may be used to implement one or more of the systems or methods described herein in accordance with certain embodiments.

FIG. 7 is a cloud computing environment that can be used to perform one or more actions according to an aspect of the present disclosure.

FIG. 8 is a block diagram of a computer system that may be used to implement one or more of the systems or methods described herein in accordance with certain embodiments.

### DETAILED DESCRIPTION

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Embodiments in accordance with the present disclosure generally relate to controlling the process upsets at wet crude handling units (WCHUs) within gas oil separation plants (GOSPs).

In upstream oil and gas processing, GOSPs perform a critical task of removing gas, water, and pollutants from crude oil. GOSPs are complex, often including a variety of processing units working in tandem as part of a processing train to achieve a “on-specification” crude oil product that is suitable for downstream processing. Production of crude oil that complies with industry quality standards is important to prevent processing errors, increase efficiency, decrease production cost, and ensure the longevity of downstream facilities. However, producing on-specification crude oil presents current operational issues where efforts to mitigate deficiencies in a GOSP may fail to account for undesirable externalities that may arise in real-time from manual adjustments made to individual units along complex GOSP processing trains. In other words, current methods for optimizing a single unit within a GOSP may negatively affect other GOSP units. Current solutions to this issue may require halting crude oil processing through the GOSP, reducing throughput and increasing costs.

To address the issue of optimizing complex GOSP systems in real-time, embodiments of the present disclosure provide an advanced and integrated control system for monitoring and adjusting individual GOSP units in real-time. The integrated control system may allow a user to optimize on-specification oil production at the GOSP without creating negative externalities typically associated with single-unit optimization. Accordingly, implementation of embodiments described herein will increase the fidelity of GOSP quality control while also increasing throughput and reducing cost.

In general, a GOSP is a facility designed to separate a crude oil mixture extracted from oil wells into its primary components: crude oil, natural gas, and water. The process of separating crude oil into its constituents begins with the production fluids entering the GOSP through an inlet manifold, which directs a flow of crude oil mixture into a separation chamber. The crude oil mixture first passes through a set of primary separation vessels (e.g., high-pressure separators), where much of the gas component is separated out from the crude oil mixture. The remaining mixture then moves to low-pressure separators for ancillary gas removal. The mixture may then undergo heat treatment, where heat and/or demulsifying agents are arranged to separate the oil from the water in the remaining mixture. The separated water may be treated to remove oil and other contaminants before being reused or disposed of in a safe manner. The separated gas may be compressed and treated to remove impurities such as hydrogen sulfide (H₂S) and carbon dioxide (CO₂), after which it may be used as fuel, sent to gas processing plants, or reinjected into a reservoir. Finally, the stabilized oil is prepared for transportation and further refining. Accordingly, GOSP processes provide for the efficient and safe separation of crude oil, natural gas, and water, enhancing the overall productivity and safety of oil production operations.

Certain GOSPs may implement or work in tandem with a WCHU to manage crude oil with a higher-than-average water content. A WCHU may process wet crude oil to separate water, sediments, and impurities from a crude oil mixture, typically via physical separation techniques such as gravity settling, centrifugation, and filtration. In one example, the WCHU may perform desalting to reduce the salt content in a crude oil mixture, preventing both corrosion and fouling in downstream processing units. This desalting process may involve mixing the crude oil with fresh water and then separating the oil and water phases. A WCHU may also perform dehydration procedures which involve removing water from the crude oil mixture to meet the specifications required for transportation and further refining. This process may involve heating the crude to break emulsions and using chemical additives to enhance separation of water and oil. Additionally, a WCHU may include storage and transfer systems for the stabilized oil for additional downstream refinement.

Often, the specific process treatment of wet crude oil in the GOSP may involve multiple units working in tandem with the GOSP and in sequence with one another. For example, in addition to a WCHU, a GOSP may include a high-pressure production trap (HPPT), a low-pressure degassing tank (LPTD), and/or water disposal unit (WDU). The wet crude oil initially undergoes treatment to separate associated gas through a HPPT and then proceeds to a LPTD to further remove remaining associated gas and formation water. The treated crude oil is then sent to the WCHU via a set of charge pumps, while the produced water is sent to a WDU via draw-off pumps.

Embodiments of the present disclosure provide systems and methods for controlling the process upset in a WCHU implemented at a GOSP. Specifically, embodiments herein provide an advanced integrated control system that may monitor and analyze real-time process parameters to ensure the plant's crude quality specifications are met. The integrated control system may proactively detect and rectify deficiencies in the system or equipment, minimizing plant upsets and meeting the target production standards. The integrated control system may utilize control valves, instruments, online analyzers, and other equipment to maintain optimal operating conditions and facilitate the advanced separation of water and salt from a wet crude mixture. Troubleshooting procedures may be implemented and optimized within the integrated control system to identify and address malfunctions in specific areas or equipment, such as heat exchangers, level control valves, and/or transformers. By responding to deviations in “real-time” and facilitating appropriate corrective action, the integrated control system may ensure the efficient and high-quality production of dry crude oil that consistently meets quality standards necessary for refining and transportation. In at least one embodiment of the present disclosure, “real-time” refers to an immediate processing and/or response to data and/or events as they occur, without substantial delay noticeable to a user. In control systems, such as those described herein, real-time systems are designed to handle inputs, process data, and provide outputs almost instantaneously, often within seconds, to ensure timely and accurate operations. This capability is critical in applications where timely decision-making and action are essential, such as in control systems for oil and gas processing.

Other benefits arising from the integrated control system described herein include reduced transformer tripping; allowance of tight emulsion procedures and increased water cut within crude oil mixtures that the existing GOSP designs cannot handle or treat; reduced cost associated with operations implemented to meet crude specifications; decreased demulsifier and wash water consumption; and minimized arcing and short-circuiting.

Embodiments of the present disclosure provide precise control of the WCHU crude oil separation process to ensure the intended crude quality specifications are met. In a typical WCHU system it is important to utilize appropriate control valves to achieve desired process parameters (e.g., flow level, flow volume, system pressure, and the like). Achieving proper control of these target parameters is achieved by way of supervision by console operators for the duration to the processing. In one example, console operators may manually monitor control valves in a distributed control system (DCS). However, current DCSs may be inadequate to control operations at the huge scale of certain GOSPs. For instance, current DCSs may be inadequate to monitor complex sequential processes implemented by a WCHU operating in sequence with other processing units in a manner congruent for each of the operating units. This may cause processing failures at one unit that can disrupt downstream processing. To address this issue, an advanced integrated control system capable of monitoring and controlling various process parameters across different units in a GOSP is provided.

The integrated control system described according to certain embodiments of the present disclosure may be configured or otherwise arranged within a GOSP to continuously monitor the most important process parameters from different units and take appropriate action in case of deviations from the optimal set points. In at least one embodiment, the integrated control system may identify important equipment and controllers in the plant, such as control valves, instruments, chemical pumps, heat exchangers, electrostatic grids, online crude analyzers, and wash water systems. Its purpose is to oversee multiple process units within the GOSP and ensure effective and automatic control without adversely affecting other units (e.g., a HPPT, a LPTD, a WDU, and the like).

Each parameter in each unit is identified along with its optimal set point and acceptable operating range. The advanced integrated control system monitors these parameters in a continuous, semi-continuous, or event-based manner. Based on the monitoring, the advanced integrated control system takes action to maintain each parameter within the desired range, thereby ensuring high-quality production. In at least one embodiment, monitoring in a continuous manner refers to a system or process that occurs without interruption, maintaining an unbroken and consistent sequence over time. “Continuous” activity implies a seamless and ongoing activity without discrete intervals or breaks, and may be essential in systems requiring constant monitoring, data acquisition, or operational functionality. For example, in real-time monitoring systems, continuous monitoring means that data is transmitted and processed without pause, ensuring up-to-date information flow and immediate response to any changes or events. Monitoring in a semi-continuous manner refers to a system or process that occurs in an ongoing manner but with periodic interruptions or breaks. “Semi-continuous” activity implies a process that is not entirely unbroken but resumes after short, predefined intervals or pauses. In industrial processes, semi-continuous operations might involve stages of batch processing interspersed with intervals of activity, allowing for some level of ongoing production while accommodating necessary interruptions for maintenance, adjustments, or transitions between stages. This approach balances the need for continuous activity with the practical requirements of operational management and resource allocation. Monitoring in an event-based manner refers to a system or process that operates in response to specific events or triggers, rather than continuously or at regular intervals. “Event-based” activity implies that actions are initiated by occurrences such as user inputs, changes in data, signals from sensors, or other defined events. This approach may be used in control system design to create responsive and efficient operations, where resources are utilized only when necessary. Event-based architectures are prevalent in real-time monitoring systems, where timely responses to dynamic conditions may optimize resource usage and efficiency.

To enhance the monitoring process implemented within an integrated control system, online analyzers may be deployed at an outlet header of a dry crude production train. These analyzers may provide real-time analysis of samples collected from a crude oil flow stream within a single unit, enabling the system to monitor whether the crude oil mixture meets target quality specification within that single unit. In certain cases, the quantity of salt in crude may be measured for crude quality specification using electromagnetic sensors, such as a salt-in-crude analyzer. Salt-in-crude may be considered the amount of chloride-based salts found in the sample in weight per volume. If the target specifications are not met, the integrated control system may assess the process parameters within the single unit and initiate corrective action in the affected equipment. This action may rectify system deficiencies of the single unit while minimizing the impact that the process parameters changes may have on other units within the GOSP (e.g., a HPPT, a LPTD, a WDU, and the like). The variable controls that can be adjusted to optimize the process parameters include, among other pieces of equipment, control valves, chemical pumps, heat exchangers, and/or any other equipment directly involved in GOSP processing. Implementation of the advanced integrated control system described according to one or more embodiment of the present disclosure may reduce human errors associated with manual monitoring of various GOSP systems. Moreover, the advanced integrated control system may minimize the need for manual intervention by providing sufficient automated control within each individual unit in a system.

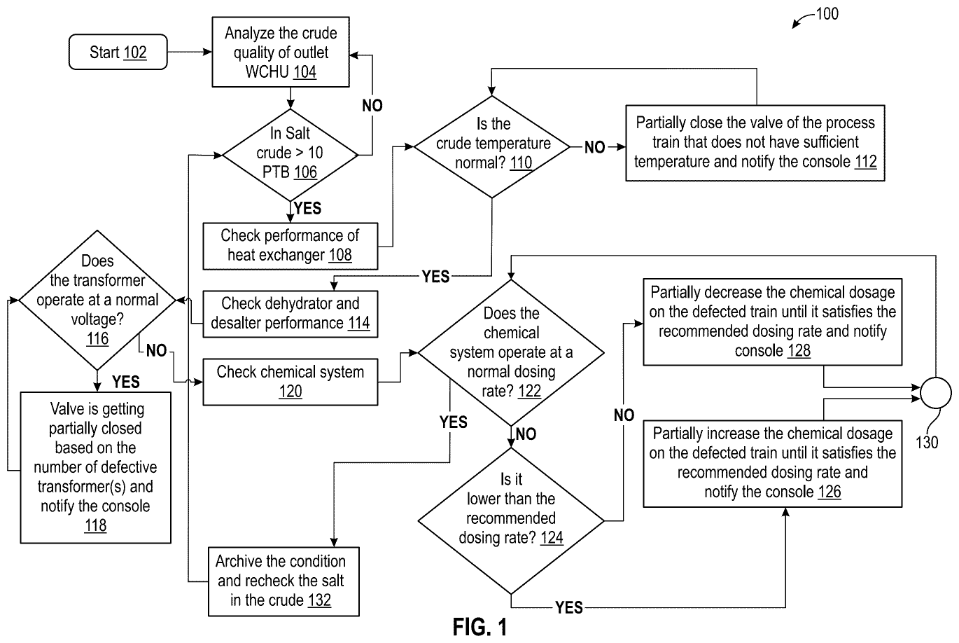

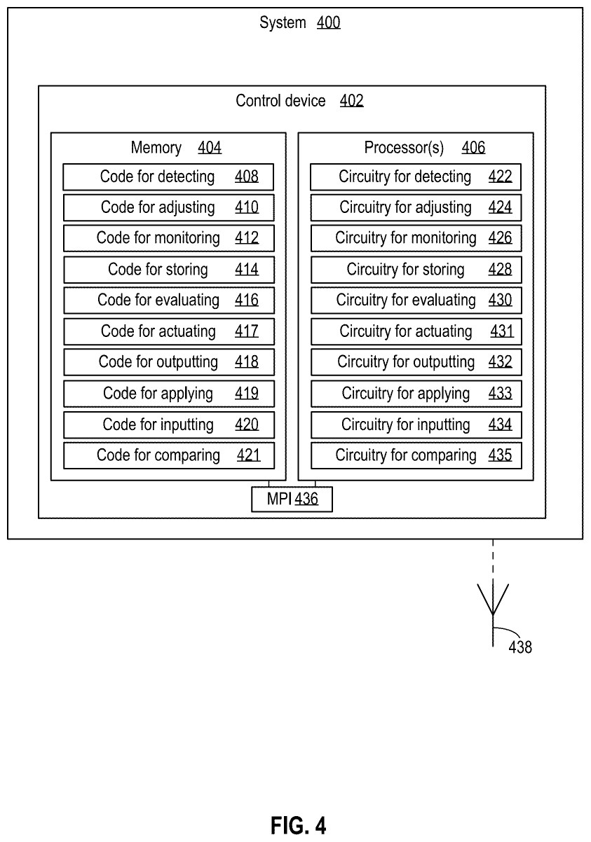

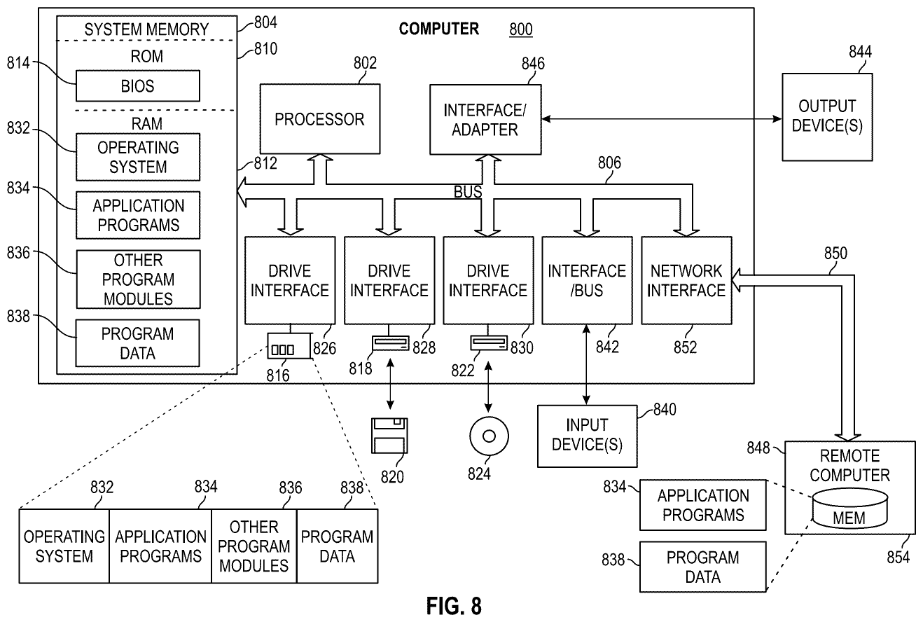

FIG. 1 is a flow diagram illustrating a procedure 100 for implementing the advanced integrated control system, described according to one or more embodiment of the present disclosure. The procedure may be implemented by a system such as the system 400 of FIG. 4, with specific implementation performed by one or more controllers (e.g., the controller of FIG. 4). The one or more controllers may have processors coupled to a memory, the one or more processors configured or otherwise arranged to perform the procedure 100. The one or more processors may be central processing units (CPUs), graphics processing units (GPUs), or the like. The one or more processors may operate in sequence, in parallel, or both in sequence and in parallel based on the needs of the integrated control system. The processors may communicate with each other via wired communication or wireless communication and may be co-located at least one of a virtual machine, a physical machine, a serverless computer architecture, and the like. The processors may store any information obtained during the course of procedure 100 via a computer system, such as the computer system 800 of FIG. 8.

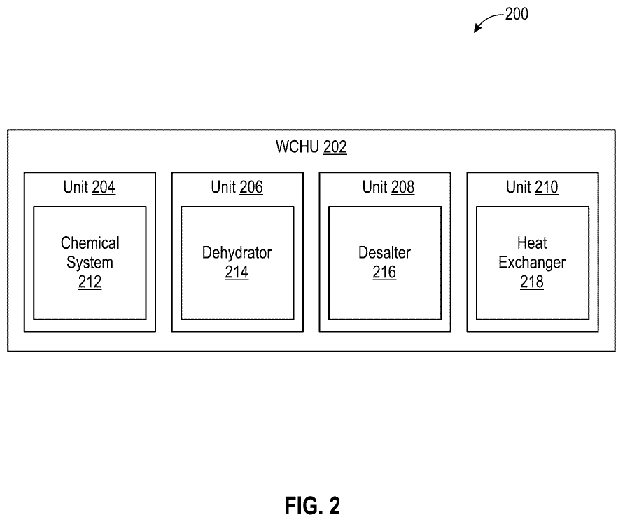

FIG. 2 is a diagram of a unit 200 within an integrated control system, which may be controlled by the integrated control system via implementation of procedure 100. The unit 200, which may be a unit installed within a GOSP and operating in sequence in other similar or dissimilar units, may be a WCHU 202. The WCHU 202 includes a unit 204 having a chemical system 212, a unit 206 having a dehydrator 214, a unit 208 having a desalter 216, and a unit 210 having a heat exchanger 218. Each of units 204-210 may include a single processing train or multiple processing trains and may be controlled by one or more valves. The units 204-210 may each process a flow of crude oil mixture according to the GOSP processes described above. The advanced integrated control system may be integrated with the WCHU 202 via the one or more controllers to monitor and adjust process parameters via the equipment in the WHCU.

The procedure 100 of FIG. 1 begins at a start point 102, and continues to step 104, where one or more processors may analyze the crude oil mixture quality detected at a manifold outlet of a WCHU (or another GOSP unit). In at least one embodiment, analyzing the crude oil mixture may include real-time analysis of samples collected from a crude oil flow stream within a single unit, as described above. Based on the analysis, the one or more processors may evaluate the salt content of the crude oil mixture. The one or more processors may, at step 106, evaluate the salt content using a pounds per thousand barrel (PTB). In at least one embodiment, step 106 may include evaluating whether the salt content meets or exceeds a certain threshold. For example, the one or more processors may determine that the salt content is greater than a salt content threshold value of about 30 PTB, or equal to or lesser than about 30 PTB. If the salt content threshold value is greater than about 30 PTB, the one or more processors may proceed to step 108. If the threshold value is equal to or lesser than about 30 PTB, the one or more processors may repeat step 104. In at least one embodiment, the one or more processors may repeat step 104 after the integrated control system adjusts process parameters within the WCHU (e.g., via equipment of the WCHU), which may optimize the salt content within the crude oil mixture to mitigate any downstream issues that may arise based on the salt content. In other embodiments, the salt content threshold value may be between about 10 PTB or more to about 50 PTB or less, such as about 20 PTB or more to about 40 PTB or less, such as about 25 PTB or more to about 35 PTB or less, such as about 28 PTB or more to about 32 PTB or less, such as about 29 PTB or more to about 31 PTB or less, such as about 30 PTB, though other values are contemplated by this disclosure.

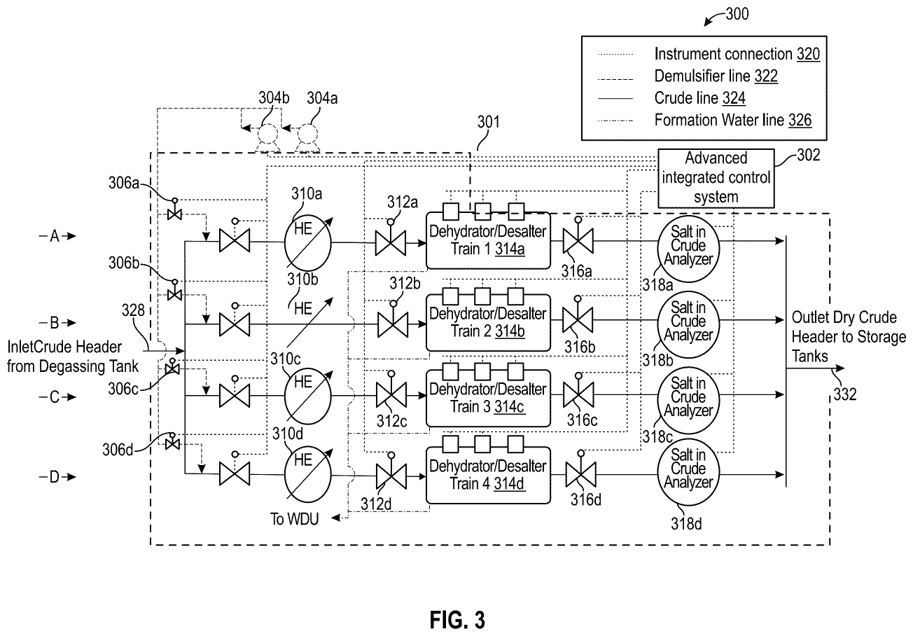

If, based on step 106 of FIG. 1, the one or more processors continue to step 108, the one or more processors perform step 108 by checking the performance of at least one heat exchanger (e.g., heat exchanger 218 of FIG. 2, heat exchangers 310a-d of FIG. 3) within the WCHU unit (e.g., WCHU 202 of FIG. 2). Step 108 includes sub-steps 110 and 112. At sub-step 110, the one or more processors evaluate whether the temperature of the crude oil mixture measured via one or more analyzers coupled to the integrated control system matches a target (e.g., normal) temperature. In at least one embodiment, sub-step 110 may include evaluating whether the temperature of the crude oil mixture is withing a certain threshold range. For example, the one or more processors may determine that the temperature of the crude oil mixture is within a temperature threshold range of about 130 degrees Fahrenheit (F) or more to about 170 degrees F. or less, or not within the temperature threshold range. If the temperature of the crude oil mixture is outside of the threshold range, the one or more processors may repeat proceed to sub-step 112. If the temperature is within the threshold range, the one or more processors may proceed to step 114. In other embodiments, the temperature threshold value may be between about 140 degrees F. or more to about 160 degrees F. or less, such as 145 degrees F. or more to about 155 degrees F. or less, such as about 147 degrees F. or more to about 154 degrees F. or less, such as about 149 degrees F. or more to about 152 degrees F. or less, though other values are contemplated by this disclosure.

At sub-step 112 of FIG. 1, the one or more processors partially close any valve along the process train (e.g., within the WCHU or other relevant unit) that may be producing temperature conditions that are insufficient for optimal processing. In at least one embodiment, closing the valve may be performed by one or more processors within a controller substantially coupled to the equipment within the process train. In at least one embodiment, the valve producing the insufficient temperature conditions may be optionally monitored by one or more analyzers, such as the analyzers discussed about. In certain embodiments, insufficient temperature conditions may occur independent from the performance of a valve; however, closing of the valve may help to cure the insufficient temperature conditions. In certain embodiments, sub-step 112 may more broadly include partially adjusting any component of a unit to achieve sufficient temperature conditions. In certain embodiments, the one or more processors may notify a console after performing an adjustment. The console may be a controller, such as a supervisory controller or an ancillary controller, or may be a user. After all relevant equipment is adjusted to achieve the target temperature, the one or more processors repeat step 110.

At step 114 of FIG. 1, the one or more processors check the performance of at least one dehydrator (e.g., dehydrator 214 of FIG. 2, dehydrator/desalter 314a-d of FIG. 3) and at least one desalter (e.g., desalter 216 of FIG. 2, dehydrator/desalter 314a-d of FIG. 3) within the WCHU. Step 114 includes sub-steps 116 and 118. At sub-step 116, the one or more processors evaluate whether the voltage of one or more transformers within a system, measured via one or more analyzers coupled to the integrated control system, matches a target (e.g., normal) voltage. In at least one embodiment, sub-step 116 may include evaluating whether the voltage of the one or more transformers is withing a certain threshold range. For example, the one or more processors may determine that the voltage of the one or more transformers is within a voltage threshold range of about 3600 volts (V) or more to about 5200 V or less, or not within the voltage threshold range. If the voltage of the one or more transformers is outside of the threshold range, the one or more processors may repeat proceed to sub-step 118. If the voltage is within the threshold range, the one or more processors may proceed to step 120. In other embodiments, the temperature threshold value may be between about 3800 V or more to about 5000 V or less, such as about 4000 V or more to about 4800 V or less, such as about 4200 V or more to about 4600 V or less, such as about 4300 V or more to about 4500 V or less, though other values are contemplated by this disclosure.

At sub-step 118 of FIG. 1, the one or more processors partially close any valve along the process train (e.g., within the WCHU or other relevant unit) that may be causing deficiencies in the performance of the one or more transformers. In at least one embodiment, closing the valve may be performed by one or more processors within a controller substantially coupled to the equipment within the process train. In at least one embodiment, the valve contributing to deficiencies in the one or more transformers conditions may be optionally monitored by one or more analyzers, such as the analyzers discussed about. In certain embodiments, one or more transformers may exhibit deficiencies independent from the performance of a valve; however, closing of the valve may help to cure the deficiencies generated from the transformer. In certain embodiments, sub-step 118 may more broadly include partially adjusting any component of a unit to achieve sufficient transformer operations. In certain embodiments, the one or more processors may notify a console after performing an adjustment. The console may be a controller, such as a supervisory controller or an ancillary controller, or may be a user. After all relevant equipment is adjusted to achieve sufficient transformer operations, the one or more processors repeat step 116.

At step 120 of FIG. 1, the one or more processors check the performance of at least one chemical system (e.g., chemical system 212 of FIG. 2, analyzer 318a-d of FIG. 3) within the WCHU. Step 120 includes sub-steps 122-132. At sub-step 122, the one or more processors evaluate whether the chemical systems, measured via one or more analyzers coupled to the integrated control system, operate at a normal dosing rate. In at least one embodiment, sub-step 122 may include evaluating whether the dosing rate at certain point along a processing train is withing a certain threshold range. For example, the one or more processors may determine that the dosing rate is within a dosing threshold range which is defined based on the trial test. Determining the dosing rate may include evaluating and identifying a suitable (e.g., optimum and/or target) dosage rate of a chemical relative to a crude oil production rate associated with the evaluated facilities. Evaluating and identifying a suitable dosage rate may be performed according to Equation (0), as follows:

$$( ppm ) = {( ( Dosage GPD * 23.8 1 / 1000 ) / Total Wet Crude BPD )}^{*} 1000000 \qquad ( 0 )$$

If the dosing rate is below or within the threshold range, the one or more processors may repeat proceed to sub-step 132. If the dosing rate is outside of the threshold range, the one or more processors may proceed to step 124.

If, based on sub-step 122 of FIG. 1, the one or more processors continue to sub-step 124, the one or more processors perform sub-step 124 by evaluating whether the dosing rate measured via one or more analyzers coupled to the integrated control system matches a target (e.g., normal) dosing rate, such as the dosing rate of Equation (0). In at least one embodiment, sub-step 124 may include evaluating whether the dosing rate meets or exceeds a certain threshold. For example, the one or more processors may determine that the dosing rate is less than a dosing rate threshold value of about 20%, or equal to or greater than about 10%. If the dosing rate threshold value is less than about 20%, the one or more processors may proceed to sub-step 126. If the threshold value is equal to or greater than about 10%, the one or more processors may repeat sub-step 128. After the performance of either sub-step 126 or sub-step 128, the one or more processors concatenate results from sub-step 126 and sub-step 128 at confluence point 130 and repeat step 122.

At sub-step 126 of FIG. 1, the one or more processors partially decrease the chemical dosage on the deficient train until the train satisfies the recommended dosing rate. In at least one embodiment, decreasing the chemical dosage may be performed by one or more processors within a controller substantially coupled to the equipment within the process train. In at least one embodiment, the chemical systems contributing to deficiencies in the dosing rate may be optionally monitored by one or more analyzers, such as the analyzers discussed about. In certain embodiments, dosing rate through the process train may exhibit deficiencies independent from the performance of a chemical system; however, adjusting the chemical system may help to cure the deficiencies. In certain embodiments, sub-step 126 may more broadly include partially adjusting any component of a unit to achieve sufficient chemical system operations. In certain embodiments, the one or more processors may notify a console after performing an adjustment. The console may be a controller, such as a supervisory controller or an ancillary controller, or may be a user.

At sub-step 128 of FIG. 1, the one or more processors partially increase the chemical dosage on the deficient train until the train satisfies the recommended dosing rate. In at least one embodiment, increasing the chemical dosage may be performed by one or more processors within a controller substantially coupled to the equipment within the process train. In at least one embodiment, the chemical systems contributing to deficiencies in the dosing rate may be optionally monitored by one or more analyzers, such as the analyzers discussed about. In certain embodiments, dosing rate through the process train may exhibit deficiencies independent from the performance of a chemical system; however, adjusting the chemical system may help to cure the deficiencies. In certain embodiments, sub-step 128 may more broadly include partially adjusting any component of a unit to achieve sufficient chemical system operations. In certain embodiments, the one or more processors may notify a console after performing an adjustment. The console may be a controller, such as a supervisory controller or an ancillary controller, or may be a user.

If, based on sub-step 122 of FIG. 1, the one or more processors continue to step 132, the one or more processors perform step 132 by archiving the condition of the crude oil mixture based on information obtained during the performance of procedure 100. After performing step 132, the one or more processors repeat step 106. Archives generated during the performance of procedure 100 may be used to further enhance the advanced integrated control system. For example, the advanced integrated control system may be improved based on implementation of certain machine learning methods, as described in detail below.

According to the embodiments provided herein, procedure 100 as implemented by the integrated control system operates in a continuous, semi-continuous, or event-based manner to facilitate robust monitoring and adjustment of a process train. Procedure 100 may be ended after processing of a crude oil mixture is ended.

FIG. 3 is a schematic diagram illustrating an example unit 300, which may be controlled by the integrated control system via implementation of procedure 100 of FIG. 1. Embodiments described with respect to FIG. 3 may be further understood with respect to the WCHU 202 of FIG. 2. The unit 300 includes a WCHU and an advanced integrated control system 302 (hereinafter, “the control system 302”). The WCHU 301 and the control system 302 are substantially coupled to one another via an instrument connection 320. In at least one embodiment, the instrument connection 320 may be a wired connection (e.g., Ethernet cables, fiber optic cables, and the like) or a wireless connection (e.g., wi-fi (wireless fidelity), Bluetooth, NFC (near field communication), cellular (fourth generation long-term evolution, fifth generation millimeter wave), LoRa (long range), satellite, and DECT (digital enhanced cordless telecommunications), and the like.

The control system 302 may be understood with reference to both the advanced integrated control system described with respect to FIG. 1 and the system 400 described with respect to FIG. 4. In at least one embodiment, the control system 302 is substantially integrated with the WCHU 301 via the instrument connection 320. Where the control system 302 is substantially integrated with the WCU 301, the instrument connection 320 may facilitate the performance of procedure 100 throughout the WCHU 301. Specifically, the instrument connection 320 may facilitate monitoring flow within a demulsifier line 322, a crude line 324, and a formation water line 326 and adjusting of at least one of heat exchangers 310a-d, dehydrator and desalter trains 314a-d, salt in crude analyzers 318a-d and instrumentation and control valves 306a-d, 308a-d, 312a-d, and 316a-d.

The WCHU 302 includes the heat exchangers 310a-d, the dehydrator and the desalter trains 314a-d, the salt in crude analyzers 318a-d and the instrumentation and control valves 306a-d, 308a-d, 312a-d, and 316a-d. The WCHU 302 further includes demulsifier pumps 304a-b, the demulsifier line 322, the crude line 324, and the formation water line 326. In at least one embodiment, the wet crude may be separated into multiple processing trains (illustrated in FIG. 3 by arrows pointing towards trains A, B, C, and D) within the WCHU 302. Each of trains A-D may be configured or otherwise arranged to remove water droplets from a crude oil mixture to achieve dry and on-specification crude oil (e.g., about 5 PTB of salt content or more to about 15 PTB of salt content or less, such as 10 PTB, though other values are contemplated). To facilitate the production of on-specification crude oil, the salt in crude analyzers 318a-d are installed downstream of each of trains A-D, and may measure the salt content of the crude oil mixture real-time (e.g., as part of procedure 100). In at least one embodiment, measurements at the crude analyzers 318a-d may be implemented by one or more processors as part of control system 301. In at least one embodiment, the WCHU 302 may detect and rectify deficiencies via the control system 301 and its integration with equipment within the WCHU 302. In at least one example, this may minimize plant upsets and increase WCHU efficiency. The control system 301 may utilize control valves, instruments, online analyzers, and other equipment to maintain optimal operating conditions and facilitate the separation of water and salt from the wet crude oil mixture.

In the example of FIG. 3, a demulsifier (not shown) is injected into the unit 300 upstream from the WCHU 302 and transported to the WCHU 302 via the demulsifier line 322. At substantially the same time, an initial crude oil mixture (not shown) enters the WCHU 302 via an inlet manifold 328 along the crude line 324. Both the initial crude oil mixture and the demulsifier are separated into each of trains A-D via their respective transport lines. The demulsifier is regulated by instrumentation and control valves 306a-d, which may be controlled by the control system 301 via the instrument connection 320. The demulsifier line 322 merges with the crude line 324, facilitating the confluence of the demulsifier with the initial crude oil mixture to produce the crude oil mixture described at length above. The crude oil mixture continues along the crude line 324 and is regulated by instrumentation and control valves 308a-d, which may be controlled by the control system 301 via the instrument connection 320. The crude oil mixture is then directed to the heat exchangers 310a-d and processed accordingly. After exiting the heat exchangers 310a-d, the crude oil mixture continues along the crude line 324 and is regulated by instrumentation and control valves 312a-d, which may be controlled by the control system 301 via the instrument connection 320. The crude oil mixture is then directed to the dehydrator and desalter trains 314a-d and processed accordingly. After exiting the dehydrator and desalter trains 314a-d, the crude oil mixture continues along the crude line 324 and is regulated by instrumentation and control valves 316a-d, which may be controlled by the control system 301 via the instrument connection 320. The crude oil mixture is then directed to the salt in crude analyzers 318a-d and processed accordingly. After exiting the dehydrator and salt in crude analyzers 318a-d, the crude oil mixture continues along the crude line 324 to be recombined. The crude oil mixture then exits the WCHU 302 via an outlet manifold.

As illustrated in the example of FIG. 3, to facilitate the GOSP separation process, demulsifier may be injected via demulsifier pumps 304a-b via demulsifier line 322. The demulsifier pumps 304a-b are upstream of the WCHU 302 to break the emulsion and aid in separating water droplets from the crude oil mixture in the dehydrator and desalter trains 314a-d. The formula (1) produced here illustrates the target demulsifier dosing rate to be injected based on the wet crude rate of the WCHU 302. Dehydrators (not shown) within the dehydrator and desalter trains 314a-d may use multiple transformers to generate an electrostatic field, enhancing water droplet coalescence under normal operating conditions.

$$Demulsifier PPM = \frac{Demulsifier Rate ( GPD ) * 23.81 * 1000}{Wet Crude Rate ( MBD )} \qquad ( 1 )$$

If crude specifications are not achieved after the crude oil mixture is processed through the WCHU 302, a troubleshooting procedure (e.g., procedure 100) may be initiated to identify the deficient area or equipment within the unit 300. The troubleshooting procedure, which may be understood with reference to procedure 100 of FIG. 1, involves checking major parameters such as temperature, flow level, and transformer voltage. The control system 300 of FIG. 300 may continuously collect and log process data, allowing for trend analysis based on real-time and historical data. If a process parameter deviates from a normal trend, the control system 300 may initiate a trend analysis procedure. A trend analysis procedure may involve evaluating historical data regarding unit 300 performance, comparing it with real-time values regarding unit 300 performance, and identifying any abnormal patterns or trends. In one example, a GOSP operator may set the normal operation of the following parameters to be as shown in Table 1. When an abnormal condition is triggered, the system may initiate an alarm analysis procedure to investigate the cause. This analysis may involve reviewing the operation history, associated process parameters, and any other relevant data to determine the source of the alarm and take appropriate action.

TABLE 1
Examples of predetermined process parameters
at advanced integrated control system.

| Parameters | Normal | Scenario |
|---|---|---|
| Temperature, | 152-149 | If it falls below 149° F., it indicates a defect in |
| F. | | the heat exchanger. In such cases, the flow |
| | | needs to be diverted to another train by |
| | | adjusting the necessary flow control valves. |
| Level, % | 60-50 | If it drops below 50%, it indicates a defect in |
| | | the level control valve. To rectify this, the |
| | | advanced integrated control system gradually |
| | | opens the level control valve until it reaches |
| | | the normal operating condition of 50%. |
| Transformer | 4500-4300 | If it falls below 4300 V, it indicates a defect |
| Voltage (V) | | in the transformer. The action taken depends on |
| | | the number of defective transformers. If one |
| | | transformer is defected, the flow control valve |
| | | needs to be gradually closed by 30%. If two |
| | | transformers are deficient, the flow control |
| | | valve needs to be gradually closed by 60%. If |
| | | three transformers are defected, the flow |
| | | control valve needs to be fully closed (100%). |

By promptly taking the appropriate corrective actions, processes within unit 300 can be effectively restored to normal conditions, ensuring the required crude specifications are met. The fast response and quick action of the advanced integrated control system are crucial in mitigating off-specification production. Thus, troubleshooting procedures described herein are implemented to identify and address malfunctions in specific areas of unit 300. By promptly responding to deviations and taking appropriate corrective actions, the advanced integrated control system helps ensure the efficient and high-quality production of dry and on-specification crude in GOSPs.

Various embodiments described herein can constitute one or more technical improvements over conventional GOSP control systems operations by enabling real-time, iteratively optimized control systems that are fully integrated into a processing train. Additionally, one or more embodiments described herein can have a practical application by training machine learning models to perform the precise monitoring and adjusting operations on a real-time basis in accordance with defined GOSP objectives. For example, one or more embodiments described herein can adjust the parameters of the integrated control system to better detect and cure deficiencies based on real-time and historical process train data.

As used herein, the term “machine learning” can refer to an application of artificial intelligence technologies to automatically and/or autonomously learn and/or improve from an experience (e.g., training data) without explicit programming of the lesson learned and/or improved upon. Machine learning as used herein can include, but is not limited to, deep learning techniques. Various system components described herein can utilize machine learning (e.g., via supervised, unsupervised, and/or reinforcement learning techniques) to perform tasks such as classification, regression, and/or clustering. Execution of machine learning tasks can be facilitated by one or more machine learning models trained on one or more training datasets in accordance with one or more model configuration settings.

As used herein, the term “machine learning model” can refer to a computer model used to facilitate one or more machine learning tasks (e.g., regression and/or classification tasks). For example, a machine learning model can represent relationships (e.g., causal or correlation relationships) between parameters and/or outcomes within the context of a specified domain. For instance, machine learning models can represent the relationships via probabilistic determinations that can be adjusted, updated, and/or redefined based on historic data and/or previous executions of a machine learning task. In various embodiments described herein, machine learning models can simulate several interconnected processing units that can resemble abstract versions of neurons. For example, the processing units can be arranged in a plurality of layers (e.g., one or more input layers, hidden layers, and/or output layers) connected by varying connection strengths (e.g., which can be commonly referred to within the art as “weights”).

Machine learning models can learn through training with one or more training datasets; where data with known outcomes in inputted into the machine learning model, outputs regarding the data are compared to the known outcomes, and/or the weights of the machine learning model are autonomously adjusted based on the comparison to replicate the known outcomes. As the one or more machine learning models train (e.g., utilize more training data), the machine learning models can become increasingly accurate; thus, trained machine learning models can accurately analyze data with unknown outcomes, based on lessons learned from training data and/or previous executions, to facilitate one or more machine learning tasks.

Example types of machine learning models can include, but are not limited to: artificial neural network (“ANN”) models, perceptron (“P”) models, feed forward (“FF”) models, radial basis network (“RBF”) models, deep feed forward (“DFF”) models, recurrent neural network (“RNN”) models, long/short memory (“LSTM”) models, gated recurrent unit (“GRU”) models, auto encoder (“AE”) models, variational AE (“VAE”) models, denoising AE (“DAE”) models, sparse AE (“SAE”) models, markov chain (“MC”) models, Hopfield network (“HN”) models, Boltzmann machine (“BM”) models, deep belief network (“DBN”) models, convolutional neural network (“CNN”) models, deep convolutional network (“DCN”) models, deconvolutional network (“DN”) models, deep convolutional inverse graphics network (“DCIGN”) models, generative adversarial network (“GAN”) models, liquid state machine (“LSM”) models, extreme learning machine (“ELM”) models, echo state network (“ESN”) models, deep residual network (“DRN”) models, kohonen network (“KN”) models, support vector machine (“SVM”) models, and/or neural turing machine (“NTM”) models.

FIG. 4 illustrates a schematic diagram of an example system 400, which includes a controller 402. The system 400 may be implemented as part of the integrated control system described with respect to FIG. 1 and the control system 300 described with respect to FIG. 3. The controller 402 may be implemented at a single location or at multiple locations and may be a supervisory controller or may be in communication with a supervisory controller by way of a communication line. In at least one embodiment, the communication line may be a wireless communication line, a wired communication line, or both, though other types of communication line are contemplated.

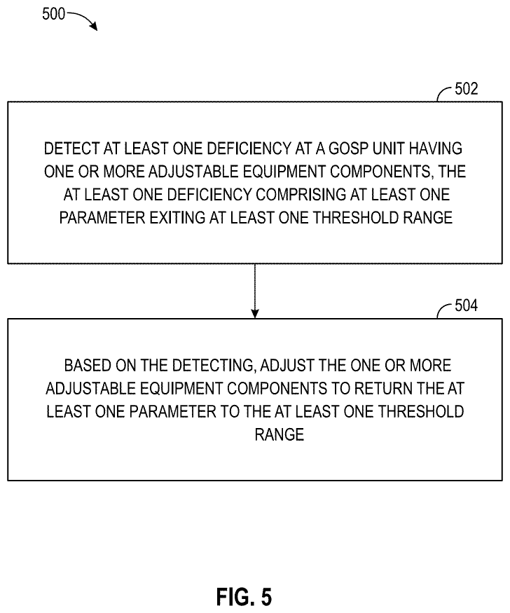

The controller 402 may include a CPU processing system, which may be configured to control the monitoring of an inflow stream for free water content, as performed by the system 400. The CPU processing system of the controller 402 may include one or more processors 406 coupled to a computer readable medium/memory 404 via a bus (not shown). The one or more processors 406 and the computer readable medium/memory 404 may communicate via a message passing interface (MPI) 436. In certain aspects the computer readable medium/memory 404 is configured to store instructions (e.g., computer executable code) that when executed by the one or more processors 406, cause the one or more processors to perform the method 500 described with respect to FIG. 5, or any aspect related to it. Reference to a processor performing a function of system 400 may include one or more processors performing that function of system 400.

In the depicted example, computer-readable medium/memory 404 stores code (e.g., executable instructions) for detecting 408, code for adjusting 410, code for monitoring 412, code for storing 414, code for evaluating 416, code for actuating 417, code for outputting 418, code for applying 419, code for inputting 420, and code for comparing 421. Processing of code 408-421 may cause the system 400 to perform the method 500 described with respect to FIG. 5, or any aspect related to it.

The one or more processors 406 include circuitry configured to implement (e.g., execute) the code stored in the computer-readable medium/memory 404, including circuitry for detecting 422, circuitry for adjusting 424, circuitry for monitoring 426, circuitry for storing 428, circuitry for evaluating 430, circuitry for actuating 431, circuitry for outputting 432, circuitry for applying 433, circuitry for inputting 434, and circuitry for comparing 435. Processing with circuitry 422-435 may cause the system 400 to perform the method 500 described with respect to FIG. 5, or any aspect related to it.

Various components of the system 400 may provide means for performing the method 500 described with respect to FIG. 5, or any aspect related to it.

The system 400 may include or be substantially coupled to a communication component 438. In the depicted example, the communication component 438 is an antenna capable of communicating with controllers similar to system 400 to perform the method 500 described with respect to FIG. 5, or any aspect related to it. In additional examples, the communication component 438 may be a bus or a wired connection.

FIG. 5 is a schematic flowchart of an example method 500 for monitoring and adjusting a WCHU by an integrated control scheme. The method 500 may be performed by one or more controllers and/or by one or more processors, such as the processors 406 of controller 402 of FIG. 4.

Method 500 begins at operation 502 with one or more processors detecting at least one deficiency at a GOSP unit having one or more adjustable equipment components, the at least one deficiency including at least one parameter exiting at least one threshold range. In at least one embodiment, the one or more adjustable equipment components include at least one of one or more valves, one or more heat exchangers, one or more chemical systems, one or more dehydrators coupled to one or more transformers, one or more desalters coupled to the one or more transformers, and one or more salt-in-crude analyzers. In at least one embodiment, the at least one parameter includes a salt content value detected at a crude oil mixture and the at least one threshold value includes a salt content threshold value. In one example, the salt content threshold value is about 30 PTB. In at least one embodiment, the at least one parameter includes a temperature value detected at a crude oil mixture and the at least one threshold value includes a temperature threshold range. In one example, the temperature threshold range is about 149 degrees F. to about 152 degrees F. In one example, adjusting the one or more adjustable equipment components includes actuating, in a partial manner, a valve associated with a heat exchanger. In at least one embodiment, the at least one parameter includes a voltage value detected at one or more transformers and the at least one threshold value includes a voltage threshold range. In one example, the voltage threshold range is about 4300 V to about 4500 V. In one example, adjusting the one or more adjustable equipment components includes actuating, in a partial manner, a valve associated with a transformer. In at least one embodiment, the at least one parameter includes a flow level value detected at a crude oil mixture and the at least one threshold value includes a flow level threshold range. In one example, the flow level threshold range is about 50% to about 60%. In at least one embodiment, the GOSP unit includes a WCHU.

Method 500 continues to operation 504 with one or more processors adjusting the one or more adjustable equipment components to return the at least one parameter to the at least one threshold range.

In at least one embodiment, the method 500 may include an operation by one or more processors to evaluate, in real-time, a temperature value of the one or more heat exchangers, evaluate, in real-time, a voltage value of the one or more transformers, and evaluate, in real-time, a dosing value of the one or more chemical systems.

In at least one embodiment, the method 500 may include an operation by one or more processors to cause the controller to perform outputting a signal to a console based on the adjusting.

In at least one embodiment, the method 500 may include an operation by one or more processors to apply a machine learning engine to the adjusting, the machine learning engine including a training engine configured to train a machine learning model and an inference engine configured to apply the machine learning model. In at least one embodiment, the training engine is configured to train a machine learning model by: inputting a training data set, the training data set based on at least one of real-time GOSP performance information generated based on the detecting and historical GOSP information; comparing, to the training data set, an output of the training engine; and based on the comparing, adjusting one or more weights of the machine learning model.

In one aspect, method 500, or any aspect related to it, may be performed by a device, such as controller 402 of FIG. 4, which includes various components operable, configured to, or adapted to perform the method 500.

FIG. 5 is just one example of a method, and other methods including fewer, additional, or alternative operations are contemplated consistent with the disclosure.

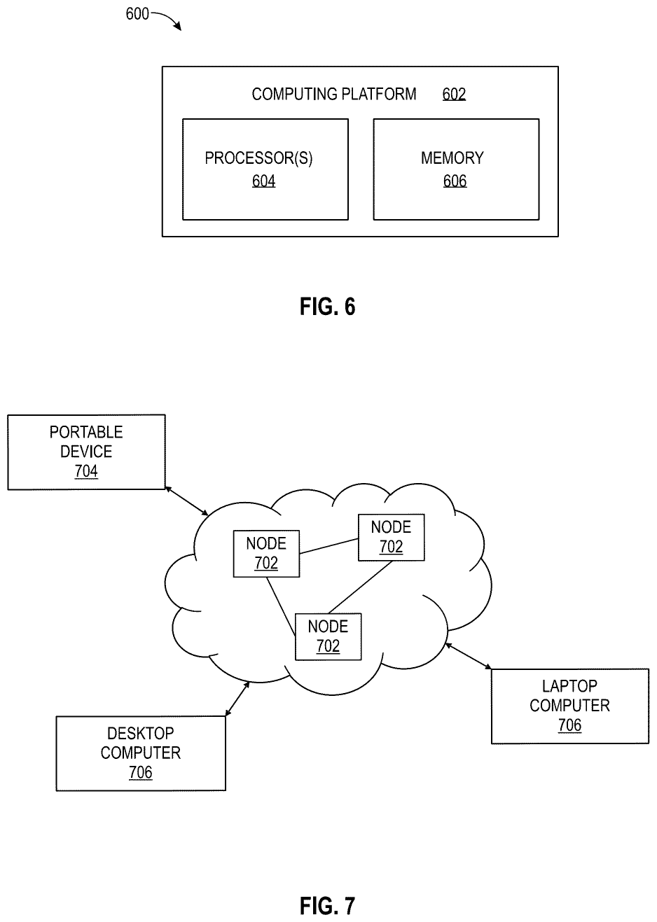

FIG. 6 is an example of a block diagram of a system 600. The system 600 can be implemented using one or more modules, shown in block form in the drawings (e.g., FIG. 1, FIG. 5). The one or more modules can be in software or hardware form, or a combination thereof. In some examples, the system 600 can be implemented as machine readable instructions for execution on one or more computing platforms 602 (referred to as a computing platform herein), as shown in FIG. 6. The computing platform 602 can include one or more computing devices selected from, for example, a desktop computer, a server, a controller, a blade, a mobile phone, a tablet, a laptop, a personal digital assistant (PDA), and the like.

The computing platform 602 can include a processor 604 and a memory 606. In at least one embodiment, the computing platform 602 may be further understood with reference to system 400 of FIG. 4. By way of example, the memory 606 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 604 can be implemented, for example, as one or more processor cores. The memory 606 can store machine-readable instructions that can be retrieved and executed by the processor 604 to implement the methods and systems described with respect to FIGS. 1-5. Each of the processor 604 and the memory 606 can be implemented on a similar or a different computing platform. The computing platform 602 can be implemented in a cloud computing environment (for example, as disclosed herein) and thus on a cloud infrastructure. In such a situation, features of the computing platform 602 can be representative of a single instance of hardware or multiple instances of hardware executing across the multiple of instances (e.g., distributed) of hardware (e.g., computers, routers, memory, processors, or a combination thereof). Alternatively, the computing platform 702 can be implemented on a single dedicated server or workstation.

In view of the structural and functional features described above, example methods will be better appreciated with reference to FIGS. 1 and 5. While, for purposes of simplicity of explanation, the example methods of FIGS. 1 and 5 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 7. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program including a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 7 illustrates one example of a computer system 700 that can be employed to execute one or more embodiments of the present disclosure. Computer system 700 can be implemented on one or more general purpose networked computer systems, embedded computer systems, routers, switches, server devices, client devices, various intermediate devices/nodes or standalone computer systems. Additionally, computer system 700 can be implemented on various mobile clients such as, for example, a personal digital assistant (PDA), laptop computer, pager, and the like, provided it includes sufficient processing capabilities.

Computer system 700 includes processing unit 702, system memory 704, and system bus 706 that couples various system components, including the system memory 704, to processing unit 702. System memory 704 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 702. System bus 706 may be any of several types of bus structure including a memory bus or memory controller, a peripheral bus, and a local bus using any of a variety of bus architectures. System memory 704 includes read only memory (ROM) 710 and random access memory (RAM) 712. A basic input/output system (BIOS) 714 can reside in ROM 710 containing the basic routines that help to transfer information among elements within computer system 700.

Computer system 700 can include a hard disk drive 716, magnetic disk drive 718, e.g., to read from or write to removable disk 720, and an optical disk drive 722, e.g., for reading CD-ROM disk 724 or to read from or write to other optical media. Hard disk drive 716, magnetic disk drive 718, and optical disk drive 722 are connected to system bus 706 by a hard disk drive interface 726, a magnetic disk drive interface 728, and an optical drive interface 730, respectively. The drives and associated computer-readable media provide nonvolatile storage of data, data structures, and computer-executable instructions for computer system 700. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A user may enter commands and information into computer system 700 through one or more input devices 740, such as a pointing device (e.g., a mouse, touch screen), keyboard, microphone, joystick, game pad, scanner, and the like. For instance, the user can employ input device 740 to edit or modify adjustment specification relevant to monitoring and adjusting by an integrated control system as described herein. These and other input devices 740 are often connected to processing unit 702 through a corresponding port interface 742 that is coupled to the system bus, but may be connected by other interfaces, such as a parallel port, serial port, or universal serial bus (USB). One or more output devices 744 (e.g., display, a monitor, printer, projector, or other type of displaying device) is also connected to system bus 706 via interface 746, such as a video adapter.

Computer system 700 may operate in a networked environment using logical connections to one or more remote computers, such as remote computer 748. Remote computer 748 may be a workstation, computer system, router, peer device, or other common network node, and typically includes many or all the elements described relative to computer system 700. The logical connections, schematically indicated at 750, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 700 can be connected to the local network through a network interface or adapter 752. When used in a WAN networking environment, computer system 700 can include a modem, or can be connected to a communications server on the LAN. The modem, which may be internal or external, can be connected to system bus 706 via an appropriate port interface. In a networked environment, application programs 734 or program data 738 depicted relative to computer system 700, or portions thereof, may be stored in a remote memory storage device 754.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models (e.g., software as a service (Saas, platform as a service (PaaS), and/or infrastructure as a service (IaaS) and at least four deployment models (e.g., private cloud, community cloud, public cloud, and/or hybrid cloud). A cloud computing environment can be service oriented with a focus on statelessness, low coupling, modularity, and semantic interoperability,

FIG. 8 is an example of a cloud computing environment 800 that can be used for implementing one or more modules and/or systems in accordance with one or more examples, as disclosed herein. Thus, reference can be made to one or more examples of FIGS. 1-7 in the example of FIG. 8. As shown, cloud computing environment 800 can include one or more cloud computing nodes 802 with which local computing devices used by cloud consumers (or users), such as, for example, personal digital assistant (PDA), cellular, or portable device 804, a desktop computer 806, and/or a laptop computer 808, may communicate. The computing nodes 802 can communicate with one another. In some examples, the computing nodes 802 can be grouped (not shown) physically or virtually, in one or more networks, such as Private, Community, Public, or Hybrid clouds, or a combination thereof. This allows the cloud computing environment 800 to offer infrastructure, platforms and/or software as services for which a cloud consumer does not need to maintain resources on a local computing device. The devices 804-808, as shown in FIG. 8, are intended to be illustrative and that computing nodes 802 and cloud computing environment 800 can communicate with any type of computerized device over any type of network and/or network addressable connection (e.g., using a web browser). In some examples, the one or more computing nodes 802 are used for implementing one or more examples disclosed herein relating to root-source identification. Thus, in some examples, the one or more computing nodes can be used to implement modules, platforms, and/or systems, as disclosed herein.

In some examples, the cloud computing environment 800 can provide one or more functional abstraction layers. It is to be understood that the cloud computing environment 800 need not provide all of the one or more functional abstraction layers (and corresponding functions and/or components), as disclosed herein. For example, the cloud computing environment 800 can provide a hardware and software layer that can include hardware and software components. Examples of hardware components include mainframes; RISC (Reduced Instruction Set Computer) architecture based servers; servers; blade servers; storage devices; and networks and networking components. In some embodiments, software components include network application server software and database software.

In some examples, the cloud computing environment 800 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 800 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 800, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 800 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 800 can provide a workloads layer that provides examples of functionality for which the cloud computing environment 800 may be utilized. Examples of workloads and functions which may be provided from this layer include mapping and navigation; software development and lifecycle management; virtual classroom education delivery; data analytics processing; and transaction processing. Various embodiments of the present disclosure can utilize the cloud computing environment 800.

Implementation examples are described in the following numbered clauses:
Aspect 1: A controller for a gas oil separation plant (GOSP), including a memory; and one or more processors coupled to the memory, the one or more processors configured to cause the controller to perform, in real-time: detecting at least one deficiency at a GOSP unit having one or more adjustable equipment components, the at least one deficiency including at least one parameter exiting at least one threshold range; and based on the detecting, adjusting the one or more adjustable equipment components to return the at least one parameter to the at least one threshold range.
Aspect 2: The controller of aspect 1, wherein the one or more processors are further configured to cause the controller to perform: monitoring, in-real time, the at least one GOSP unit; and storing GOSP performance information generated based on the detecting.
Aspect 3: The controller of any one of aspects 1 through 2, wherein the one or more adjustable equipment components include at least one of: one or more valves; one or more heat exchangers; one or more chemical systems; one or more dehydrators coupled to one or more transformers; one or more desalters coupled to the one or more transformers; and one or more salt-in-crude analyzers.
Aspect 4: The controller of aspect 3, wherein the one or more processors are further configured to cause the controller to perform at least one of: evaluating, in real-time, a temperature value of the one or more heat exchangers; evaluating, in real-time, a voltage value of the one or more transformers; and evaluating, in real-time, a dosing value of the one or more chemical systems.
Aspect 5: The controller of any one of aspects 1 through 4, wherein the at least one parameter includes a salt content value detected at a crude oil mixture and the at least one threshold value includes a salt content threshold value.
Aspect 6: The controller of aspect 5, wherein the salt content threshold value is about 30 pounds per thousand barrel (PTB).
Aspect 7: The controller of any one of aspects 1 through 6, wherein the at least one parameter includes a temperature value detected at a crude oil mixture and the at least one threshold value includes a temperature threshold range.
Aspect 8: The controller of aspect 7, wherein the temperature threshold range is about 149 degrees Fahrenheit (F) to about 152 degrees F.
Aspect 9: The controller of any one of aspects 7 through 8, wherein adjusting the one or more adjustable equipment components includes actuating, in a partial manner, a valve associated with a heat exchanger.
Aspect 10: The controller of any one of aspects 1 through 9, wherein the at least one parameter includes a voltage value detected at one or more transformers and the at least one threshold value includes a voltage threshold range.
Aspect 11: The controller of aspect 10, wherein the voltage threshold range is about 4300 volts (V) to about 4500 V.
Aspect 12: The controller of any one of aspects 10 through 11, wherein adjusting the one or more adjustable equipment components includes actuating, in a partial manner, a valve associated with a transformer.
Aspect 13: The controller of any one of aspects 1 through 12, wherein the at least one parameter includes a flow level value detected at a crude oil mixture and the at least one threshold value includes a flow level threshold range.
Aspect 14: The controller of aspect 13, wherein the flow level threshold range is about 50% to about 60%.
Aspect 15: The controller of any one of aspects 1 through 14, wherein the one or more processors are further configured to cause the controller to perform outputting a signal to a console based on the adjusting.
Aspect 16: The controller of any one of aspects 1 through 15, wherein the one or more processors include at least one supervisory processor and one or more ancillary processors.
Aspect 17: The controller of any one of aspects 1 through 16, wherein the GOSP unit includes a wet crude handling unit (WCHU).
Aspect 18: The controller of aspect 17, wherein the controller is integrated and in communication with the WCHU via an instrument connection.
Aspect 19: The controller of any one of aspects 1 through 18, wherein the one or more processors are further configured to cause the controller to perform: applying a machine learning engine to the adjusting, the machine learning engine comprising a training engine configured to train a machine learning model and an inference engine configured to apply the machine learning model.
Aspect 20: The monitoring system of aspect 19, wherein the training engine is configured to train a machine learning model by: inputting a training data set, the training data set based on at least one of real-time GOSP performance information generated based on the detecting and historical GOSP information; comparing, to the training data set, an output of the training engine; and, based on the comparing, adjusting one or more weights of the machine learning model.
Aspect 21: A system for a gas oil separation plant (GOSP), including: a wet crude handling unit (WCHU) coupled to and in communication with a controller; and a controller, including: a memory; and one or more processors coupled to the memory, the one or more processors configured to cause the controller to perform, in real-time: detecting at least one deficiency at a GOSP unit having one or more adjustable equipment components, the at least one deficiency comprising at least one parameter exiting at least one threshold range; and based on the detecting, adjusting the one or more adjustable equipment components to return the at least one parameter to the at least one threshold range.
Aspect 22: A method for a gas oil separation plant (GOSP), comprising: monitoring, in-real time, the at least one GOSP unit; detecting, at least one deficiency at the GOSP unit having one or more adjustable equipment components, the at least one deficiency comprising at least one parameter exiting at least one threshold range; based on the detecting, adjusting the one or more adjustable equipment components to return the at least one parameter to the at least one threshold range; and storing GOSP performance information, the GOSP performance information generated based on the detecting.
Aspect 23: An apparatus or device including a memory comprising executable instructions, and a processor configured to execute the executable instructions and cause the apparatus to perform a method in accordance with any one of aspects 1-22.
Aspect 24: An apparatus or device, including means for performing a method in accordance with any one of aspects 1-22.
Aspect 25: A non-transitory computer-readable medium including executable instructions that, when executed by a processor of an apparatus, cause the apparatus to perform a method in accordance with any one of aspects 1-22.
Aspect 26: A computer program product embodied on a computer-readable storage medium comprising code for performing a method in accordance with any one of aspects 1-22.

The present disclosure may be a system, a method, and/or a computer program product at any possible technical detail level of integration. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

The terminology used herein is for the purpose of describing particular embodiments only and is not intended to be limiting of the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure is not limited to the particular embodiments disclosed, or to the best mode contemplated for carrying out this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The disclosure claimed is:

1. A controller for a gas oil separation plant (GOSP), comprising:
a memory; and
one or more processors coupled to the memory, the one or more processors configured to cause the controller to perform, in real-time:
detecting at least one deficiency at a GOSP unit having one or more adjustable equipment components, the at least one deficiency comprising at least one parameter exiting at least one threshold range; and
based on the detecting, adjusting the one or more adjustable equipment components to return the at least one parameter to the at least one threshold range.

2. The controller of claim 1, wherein the one or more processors are further configured to cause the controller to perform:
monitoring, in-real time, the at least one GOSP unit; and
storing GOSP performance information generated based on the detecting.

3. The controller of claim 1, wherein the one or more adjustable equipment components comprise at least one of:
one or more valves;
one or more heat exchangers;
one or more chemical systems;
one or more dehydrators coupled to one or more transformers;
one or more desalters coupled to the one or more transformers; and
one or more salt-in-crude analyzers.

4. The controller of claim 3, wherein the one or more processors are further configured to cause the controller to perform at least one of:
evaluating, in real-time, a temperature value of the one or more heat exchangers;
evaluating, in real-time, a voltage value of the one or more transformers; and
evaluating, in real-time, a dosing value of the one or more chemical systems.

5. The controller of claim 1, wherein the at least one parameter comprises a salt content value detected at a crude oil mixture and the at least one threshold value comprises a salt content threshold value.

6. The controller of claim 5, wherein the salt content threshold value is about 30 pounds per thousand barrel (PTB).

7. The controller of claim 1, wherein the at least one parameter comprises a temperature value detected at a crude oil mixture and the at least one threshold value comprises a temperature threshold range.

8. The controller of claim 7, wherein the temperature threshold range is about 149 degrees Fahrenheit (F) to about 152 degrees F.

9. The controller of claim 7, wherein adjusting the one or more adjustable equipment components comprises actuating, in a partial manner, a valve associated with a heat exchanger.

10. The controller of claim 1, wherein the at least one parameter comprises a voltage value detected at one or more transformers and the at least one threshold value comprises a voltage threshold range.

11. The controller of claim 10, wherein the voltage threshold range is about 4300 volts (V) to about 4500 V.

12. The controller of claim 10, wherein adjusting the one or more adjustable equipment components comprises actuating, in a partial manner, a valve associated with a transformer.

13. The controller of claim 1, wherein the at least one parameter comprises a flow level value detected at a crude oil mixture and the at least one threshold value comprises a flow level threshold range.

14. The controller of claim 13, wherein the flow level threshold range is about 50% to about 60%.

15. The controller of claim 1, wherein the one or more processors are further configured to cause the controller to perform outputting a signal to a console based on the adjusting.

16. The controller of claim 1, wherein the one or more processors comprise at least one supervisory processor and one or more ancillary processors.

17. The controller of claim 1, wherein the GOSP unit comprises a wet crude handling unit (WCHU).

18. The controller of claim 17, wherein the controller is integrated and in communication with the WCHU via an instrument connection.

19. The controller of claim 1, wherein the one or more processors are further configured to cause the controller to perform:
applying a machine learning engine to the adjusting, the machine learning engine comprising a training engine configured to train a machine learning model and an inference engine configured to apply the machine learning model.

20. The monitoring system of claim 19, wherein the training engine is configured to train a machine learning model by:
inputting a training data set, the training data set based on at least one of real-time GOSP performance information generated based on the detecting and historical GOSP information;
comparing, to the training data set, an output of the training engine; and
based on the comparing, adjusting one or more weights of the machine learning model.

21. A system for a gas oil separation plant (GOSP), comprising:
a wet crude handling unit (WCHU) coupled to and in communication with a controller; and
a controller, comprising:
a memory; and
one or more processors coupled to the memory, the one or more processors configured to cause the controller to perform, in real-time:
detecting at least one deficiency at a GOSP unit having one or more adjustable equipment components, the at least one deficiency comprising at least one parameter exiting at least one threshold range; and
based on the detecting, adjusting the one or more adjustable equipment components to return the at least one parameter to the at least one threshold range.

22. A method for a gas oil separation plant (GOSP), comprising:
monitoring, in-real time, the at least one GOSP unit;
detecting, at least one deficiency at the GOSP unit having one or more adjustable equipment components, the at least one deficiency comprising at least one parameter exiting at least one threshold range;
based on the detecting, adjusting the one or more adjustable equipment components to return the at least one parameter to the at least one threshold range; and
storing GOSP performance information, the GOSP performance information generated based on the detecting.
